(19) United States
(12) Patent Application Publication
(10) Pub. No.: US 2011/0070481 A1
(43) Pub. Date: Mar. 24, 2011

(54) PROTECTIVE MATERIAL AND ENERGY STORAGE MODULE USING THE SAME

(75) Inventors: Rong-Chang LIANG, Cupertino, CA (US); Chieh-Lin Hsing, Taoyuan Hsien (TW); Hsiao-Wen Huang, Taoyuan Hsien (TW); Mei-Yu Yeh, Taoyuan Hsien (TW)

(73) Assignee: DELTA ELECTRONICS, INC., Taoyuan Hsien (TW)

(21) Appl. No.: 12/877,404

(22) Filed: Sep. 8, 2010

Related U.S. Application Data
(60) Provisional application No. 61/240,387, filed on Sep. 8, 2009.

(51) Int. Cl. H01M 2/02; C09D 137/00; B32B 27/00; H01G 9/08

(52) U.S. Cl. 429/163; 523/134; 428/220; 361/517

(57) ABSTRACT

The present invention provides a protective material, which includes an acidic material and an absorbent additive. An alkaline electrolyte will be neutralized by the acidic material, and water produced from the neutralization reaction of the acidic material and the alkaline electrolyte will be absorbed by the absorbent additive. In addition, the present invention also discloses an energy storage module using the same.

### CROSS REFERENCE TO RELATED APPLICATIONS

This application claims the benefit of U.S. Provisional Application No. 61/240,387 filed on Sep. 8, 2009, entitled “PROTECTIVE MATERIAL AND ENERGY STORAGE ASSEMBLY USING PROTECTIVE MATERIAL,” which application is hereby incorporated herein by reference.

### BACKGROUND OF THE INVENTION

1. Field of the Invention

The invention relates to a protective material and an energy storage module using the same.

2. Description of the Related Art

A commonly used energy storage device, such as a nickel hydrogen battery, a nickel cadmium battery, a zinc air battery, an electric double layer capacitor, an electrolytic capacitor, or an alkaline fuel cell, often uses an alkaline solution to serve as an electrolyte. This kind of energy storage device usually comprises a wrapping on the outside. However, the wrapping can only provide a weak chemical and/or physical protection while leakage eventually may occur. If leakage does occur, the alkaline electrolyte solution leaking from a battery would damage electronic devices around the battery. Therefore, it is needed to develop a novel protective material and/or a device using the same for preventing battery leakage from occurring for damage protection.

### BRIEF SUMMARY OF THE INVENTION

In view of the foregoing, the invention discloses a protective material. The protective material provides leakage protection.

In one embodiment, the disclosed protective material comprises an acidic material and an absorbent additive. An alkaline electrolyte will be neutralized by the acidic material, and water produced from the neutralization reaction of the acidic material and the alkaline electrolyte will be absorbed by the absorbent additive.

In addition, the present invention also discloses an energy storage module using the same.

In one embodiment, the disclosed energy storage module comprises an energy storage device and the protective material as described above. The protective material is coated on the energy storage device to provide electrolyte solution leakage protection for the energy storage device.

The protective material may be filled within a housing having the storage device therein or directly coated on the energy storage device, and when leakage occurs, the alkaline electrolyte solution will be neutralized by the acidic material and water produced by neutralization will be absorbed by the absorbent additive.

A detailed description is given in the following embodiments with reference to the accompanying drawings.

### BRIEF DESCRIPTION OF THE DRAWINGS

The present invention can be further understood by reading the subsequent detailed description and examples with references made to the accompanying drawings, wherein:

FIG. 1A shows a schematic view of an energy storage module in accordance with an embodiment of the present invention;

FIG. 1B shows a cross-view of an embodiment of the energy storage module illustrated in FIG. 1A.

FIG. 1C shows a cross-view of another embodiment of the energy storage module illustrated in FIG. 1A.

FIG. 2A shows a schematic view of an energy storage module in accordance with yet another embodiment of the present invention.

FIG. 2B is a cross-view of an embodiment of the energy storage module illustrated in FIG. 2A.

### DETAILED DESCRIPTION OF THE INVENTION

The following description is of the best-contemplated mode of carrying out the invention. It is understood that the following disclosure provides many different embodiments, or examples, for implementing different features of the invention. Specific examples of components and arrangements are described below to simplify the present disclosure. These are, of course, merely examples and are not intended to be limiting. For example, the formation of a first feature over, above, below, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. The scope of the invention is best determined by reference to the appended claims.

The present invention provides a protective material which can prevent an alkaline electrolyte or other liquids from leaking therethrough. The protective material may comprise an acidic material, an absorbent additive and a binder coupling the acidic material and the absorbent additive. The coupling of the acidic material and the absorbent additive may be performed, for example, by a process of radiation, heat, moisture or combination thereof. In one embodiment, the acidic material and the absorbent additive may be crosslinked by the binder through covalent bonding. In another embodiment, the acidic material, the acidic material and the absorbent additive may be crosslinked by the binder through columbic interaction or hydrophobic interaction. Alternatively, in yet another embodiment, the acidic material and the absorbent additive may be physically crosslinked by the binder through hard and soft block soft separation.

The acidic material may comprise an organic acid, an organic acid anhydride, or combinations thereof. The acidic material may comprise an acid or an acid precursor. In one embodiment, the acidic material may comprise, but is not limited to, citric acid, tartaric acid, stearic acid, salicylic acid, succinic acid, maleic acid, maleic anhydride, phthalic acid, phthalic anhydride, naphthalic acid, naphthalic anhydride, derivatives thereof, or combinations thereof. In another embodiment, the acidic material, for example, may comprise, but is not limited to, poly(styrene-co-maleic anhydride), poly(maleic anhydride-alt-1-octadecene), poly(propylene-graft-maleic anhydride), poly(styrene-alt-maleic anhydride), poly(ethylene-co-ethyl acrylate-co-maleic anhydride), polyethylene-graft-maleic anhydride, polypropylene-graft-maleic anhydride, polyisoprene-graft-maleic anhydride, poly(ethylene-alt-maleic anhydride), poly(isobutylene-alt maleic anhydride), poly(methyl vinyl ether-alt-maleic anhydride), poly(maleic anhydride-alt-1-octadecene) or combinations thereof.

In one embodiment, the absorbent additive may comprise, but is not limited to, cotton, starch, cellulose, polysaccharide, polyacrylate, poly(diacetone-acrylamide), polyvinylalcohol, poly(ethylene glycol)diacrylate, silica, poly-2-hydroxyethyl methacrylate, agarose or combinations thereof. Furthermore, the binder may comprise, but is not limited to, aromatic urethane acrylates, aliphatic urethane acrylates, epoxy acrylates, acrylic acrylates, polyether acrylates, polyesters acrylates, oxyethylated phenol acrylate, phenoxyethyl acrylate, polyethylene glycol diacrylate, polyether triacrylate, polyether tetraacrylate, or combinations thereof.

In one embodiment, the protective material may have from about 15 to 25 wt % of the acidic material, from about 90 to 95 wt % of the absorbent additive based, and from about 5 to 10 wt % of the binder, based on the total weight of the absorbent additive and the binder.

In the present embodiment, the acidic material is capable of neutralizing an alkaline electrolyte, which is a so-called neutralization reaction. Furthermore, during the neutralization reaction, water may be also generated since it is a by-product of the neutralization reaction. Therefore, a liquid comprising a remaining portion of the alkaline electrolyte not neutralized by the acidic material (if there is not enough time to completely neutralize the alkaline electrolyte) and water produced from the neutralization reaction would still be present and in need of absorption. In the present embodiment, the leaked alkaline electrolyte and the water are capable of being absorbed and held by the absorbent additive. Thus, there is minimal probability that an alkaline solution or other liquids would leak to the outside of the protective material.

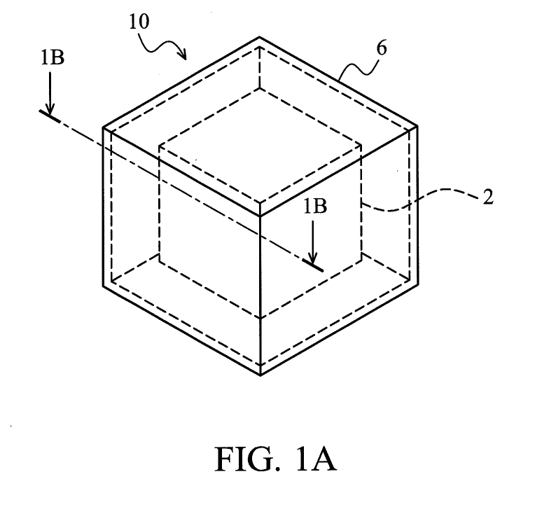

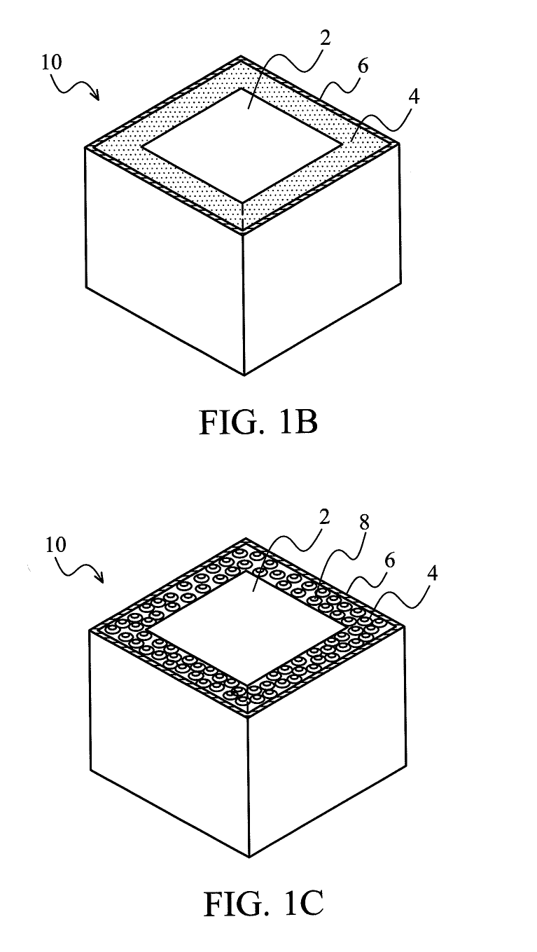

FIG. 1A shows an energy storage module 10 using the protective material in accordance with an embodiment of the present invention, and FIG. 1B shows a cross view of an embodiment of the energy storage module 10 along line 1B-1B in FIG. 1A. Referring to FIG. 1A, in this embodiment, an energy storage device 2 is provided within a housing 6. The energy storage device 2 may be, for example, an alkaline battery, an alkaline capacitor or combinations thereof. The energy storage device 2 may comprise a cubic-like shape, a round shape or any other suitable shapes. It should be noted that the cubic-like shaped energy storage device is shown in the Figures for illustrative purposes only, and is not meant to limit the disclosure in any manner. The housing 6 may be formed of any suitable material which may provide sufficient mechanical strength to protect the energy storage device 2 from external forces, and may also optionally provide chemical resistance. Referring to FIG. 1B, the space between the energy storage device 2 and the housing 6 may be directly filled with the protective material 4. As described above, the protective material 4 may absorb the alkaline solution leaked from the energy storage device 2 and the water produced from the neutralization reaction. Therefore, the protective material 4 may assure that the energy storage device 2 is dry and clean. Other electronic devices adjacent to the energy storage module 10 (not shown) would also be protected from chemical corrosion of an alkaline electrolyte solution.

Notice that, in other embodiments of the energy storage device 2, the protective material 4 may be only coated on a core 8 and form a protective ball. The core 8 may be formed of a material such as resins, carbon, graphite, alumina, silica, titania, aluminum nitride or combinations thereof. That is, the protective material 4 may be filled into the space between the energy storage device 2 and the housing 6 by the protective ball, as shown in FIG. 1C.

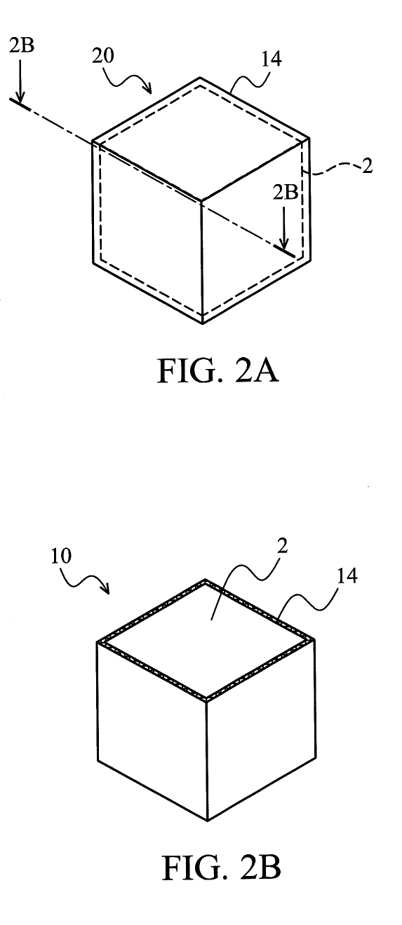

FIG. 2A shows an energy storage module 20 using the same in accordance with an embodiment of the present invention, and FIG. 2B shows a cross view of an embodiment of the energy storage module 20 along line 2B-2B in FIG. 2A. It should be noted that, in this embodiment, same reference numbers mean similar materials or formation methods as described in the above embodiments. As shown in FIGS. 2A and 2B, an energy storage device 2 is wrapped by a protective coating material 14. The protective coating material 14 may be formed of the protective material described above. For example, the protective coating material 14 may comprise an acidic material, an absorbent additive and a binder coupling the acidic material and the absorbent additive. The coupling, such as crosslink or physical crosslink, of the acidic material and the absorbent additive may result in a good adhesive property of the protective coating material.

In the embodiment of the coating films, the protective coating material 14 may further comprise an initiator to help perform a polymerization reaction for the binder. The initiator may be a photoinitiator, such as SB-PI718 (produced by Shuang-Bang industrial corp.). In addition, the protective material may further comprise a dispersing agent, such as BYK-164 (produced by BYK-Chemie), for uniformly dispersing the acidic material and the absorbent additive in a solvent, such as an organic solvent. The uniform dispersing may result in a coating film 14 uniformly wrapping the energy storage device 2, especially, it is needed while the absorbent additive has at least a portion of inorganic material such as silica.

In this embodiment, the protective coating material 14 may have a thickness of about 10 to 100 μm and a surface coverage of about 250 to 320 g/m². Furthermore, the protective coating material 14 is able to be folded or bent to fit different required shapes. Therefore, the protective coating film 14 may provide a completely closed environment for wrapping the energy storage device 2. As such, other electronic devices (not shown) adjacent to the energy storage module 20, not shown, would be prevented from chemical corrosion of an alkaline electrolyte solution and the energy storage device 2 would be able to stay dry and clean. Furthermore, the protective coating material 14 of the present invention may have good adhesion to the energy storage device 2, such that a more durable energy storage module is provided.

### Examples

The components and amounts thereof given in Table 1 were used to prepare the protective materials. Herein, poly(ethyleneglycol diacrylate) and silica was used as the absorbent additive; poly(styrene-co-maleic anhydride) was used as the acidic material; trimethylpropane ethoxylate triacrylate (TEMOPA) was used as the binder; BYK-164 was used as the dispersing agent; and SB-PI718 by was used as the initiator. At first, poly(ethyleneglycol diacrylate), silica, and BYK164 were uniformly dispersed in ethylacetate (EA), and then mixed with TEMOPA, poly(styrene-co-maleic anhydride) and SB-PI718 for carrying out the polymerization and the cross-linking reaction. Next, the mixed solution was coated on an Al pouch with a corona treatment. Finally, EA was removed by baking and the coating film was cured by UV, wherein a resulting sample was formed.

TABLE 1

| | Absorbent | | Dispersing | | Acidic | |
|---|---|---|---|---|---|---|
| Sample No. | additive | Silica | agent | Binder | material | Initiator |
| 1 | 9.025 g | 0.6 g | 0.006 g | 0.475 g | 1.9 g | 0.19 g |
| 2 | 9.025 g | 0.6 g | 0.018 g | 0.475 g | 1.9 g | 0.19 g |
| 3 | 9.025 g | 0.6 g | 0.030 g | 0.475 g | 1.9 g | 0.19 g |
| 4 | 9.025 g | 0.6 g | 0.018 g | 0.97 g | 1.9 g | 0.19 g |
| 5 | 9.025 g | 0.6 g | 0.030 g | 0.95 g | 1.9 g | 0.19 g |

A tape test according to ASTM D3359 was performed to the samples listed in Table 1 to test their adhesive properties, and the results are shown in Table 2. It was found that, the numbers of peeled (film) checks were decreased with an increasing amount of the binder was added. Thus, the crosslink of the acidic material and the absorbent additive were become stronger and can effectively enhance the adhesion of the coating film. In particular, for Sample 5, the numbers of peeled (film) checks were decreased to lower than about 5 and can be rated as 4B according to the ASTM D3359 scale.

TABLE 2

| | Numbers of peeled | Numbers of peeled | Rating |
|---|---|---|---|
| Sample | (film) checks | (film) checks | according |
| No. | (1^{st} time) | (2^{nd} time) | to ASTM D3359 |
| Sample 1 | 18 | 23 | 2B |
| Sample 2 | 25 | 29 | 2B |
| Sample 3 | 19 | 14 | 2B |
| Sample 4 | 9 | 10 | 3B |
| Sample 5 | 5 | 4 | 4B |

TABLE 3

| | Water absorption | Water absorption | Water absorption |
|---|---|---|---|
| Sample No. | (1 hrs) | (2 hrs) | (2 days) |
| 4 | 45% | 52% | 68% |
| 5 | 42% | 55% | 72% |

Table 3 shows the water absorption of the coating film. The water absorption was measured by measuring the additional weight of the protective material after absorbing water for a period of time. It was found that, the protective material absorbed the water to about 50 wt % (based on the original weight of the protective material) after 2 hours and to about 70 wt % after 2 days.

In summary, the present invention provides a protective material and an energy storage module using the same. The protective material is made from an acidic material and absorbent additive to prevent leakage therethrough and can keep an energy storage device clean and dry. In addition, the protective material may have a better adhesive property since the acidic material and the absorbent additive are strongly coupled. The protective material may be filled within a housing having the storage device therein or directly coated on the energy storage device. Hence, the energy storage module of the present invention may be suitable for many kinds of electrical devices or applications.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A protective coating material for energy storage devices, the protective coating material comprising:
an acidic material capable of neutralizing an alkaline electrolyte;
an absorbent additive capable of holding the electrolyte leaking out from the energy storage device; and
a binder coupling the acidic material and the absorbent additive.

2. The protective coating material of claim 1, wherein the acidic material and the absorbent additive are crosslinked by the binder through covalent bonding.

3. The protective coating material of claim 1, wherein the acidic material, the absorbent additive are crosslinked by the binder through columbic interaction.

4. The protective coating material of claim 1, wherein the acidic material and the absorbent additive and the binder are crosslinked by the binder through hydrophobic interaction.

5. The protective coating material of claim 1, the acidic material and the absorbent additive are physically crosslinked by the binder through hard and soft block phase separation.

6. The protective coating material of claim 1, the coupling of the acidic material and the absorbent additive is performed by a process of radiation, heat, moisture, or combinations thereof.

7. The protective coating material of claim 1, wherein the binder comprises aromatic urethane acrylates, aliphatic urethane acrylates, epoxy acrylates, acrylic acrylates, polyether acrylates, polyesters acrylates, oxyethylated phenol acrylate, phenoxyethyl acrylate, polyethylene glycol diacrylate, polyether triacrylate, polyether tetraacrylate, or combinations thereof.

8. The protective coating material of claim 1, wherein the binder is from about 5 to 10 wt % of total weight of the absorbent additive and the binder.

9. The protective coating material of claim 1, wherein the acidic material comprises an organic acid, an organic acid anhydride, or the combinations thereof.

10. The protective coating material of claim 9, wherein the acidic material comprises citric acid, tartaric acid, stearic acid, salicylic acid, succinic acid, maleic acid, maleic anhydride, phthalic acid, phthalic anhydride, naphthalic acid, naphthalic anhydride, derivatives thereof, or combinations thereof.

11. The protective coating material of claim 9, wherein the acidic material comprises poly(styrene-co-maleic anhydride), poly(maleic anhydride-alt-1-octadecene), poly(propylene-graft-maleic anhydride), poly(styrene-co maleic anhydride), poly(styrene-alt-maleic anhydride), poly(ethylene-co-ethyl acrylate-co-maleic anhydride), polyethylene-graft-maleic anhydride, polypropylene-graft-maleic anhydride, polyisoprene-graft-maleic anhydride, poly(ethylene-alt-maleic anhydride), poly(isobutylene-alt maleic anhydride), poly(methyl vinyl ether-alt-maleic anhydride), poly(maleic anhydride-alt-1-octadecene) or combinations thereof.

12. The protective coating material of claim 1, wherein the acidic material is from about 15 to 25 wt % of total weight of the absorbent additive and the binder.

13. The protective coating material of claim 1, wherein the absorbent additive comprises cotton, starch, cellulose, polysaccharide, polyacrylate, poly(diacetone-acrylamide), polyvinylalcohol, poly(ethylene glycol)diacrylate, silica, poly-2-hydroxyethyl methacrylate, agarose, 2-hydroxyethyl methacrylate (HEMA), trimethylpropane ethoxylate triacrylate or combinations thereof.

14. The protective coating material of claim 1, wherein the absorbent additive is from about 90 to 95 wt % of total weight of the absorbent additive and the binder.

15. The protective coating material of claim 1, which is being coated on a surface of the energy storage device.

16. The protective coating material of claim 15, wherein the protective coating material has a surface coverage from about 250 g/m² to 320 g/m².

17. The protective coating material of claim 15, wherein the protective coating material has a thickness of from about 10 to 100 μm.

18. The protective coating material of claim 15, wherein the energy storage device comprises an alkaline battery, an alkaline capacitor or combinations thereof.

19. An energy storage module, comprising:
at least one energy storage device;
a protective material, comprising:
an acidic material capable of neutralizing an alkaline electrolyte;
an absorbent additive capable of holding the electrolyte leaking out from the energy storage device; and
a binder coupling the acidic material and the absorbent additive; and
a housing enclosing the energy storage device, wherein the protective material is filled between the housing and the at least one energy storage device.

20. The energy storage module of claim 19, wherein the acidic material and the absorbent additive are crosslinked by the binder through covalent bonding.

21. The energy storage module of claim 19, wherein the acidic material and the absorbent additive are crosslinked by the binder through columbic interaction

22. The energy storage module of claim 19, wherein the acidic material and the absorbent additive are crosslinked by the binder through hydrophobic interaction

23. The energy storage module of claim 19, wherein the acidic material and the absorbent additive are physically crosslinked by the binder through hard and soft block phase separation.

24. The energy storage module of claim 19, wherein the coupling of the acidic material and the absorbent additive is performed by a processes of radiation, heat, moisture or combination thereof.

25. The energy storage module of claim 19, wherein the binder comprises aromatic urethane acrylates, aliphatic urethane acrylates, epoxy acrylates, acrylic acrylates, polyether acrylates, polyesters acrylates, oxyethylated phenol acrylate, phenoxyethyl acrylate, polyethylene glycol diacrylate, polyether triacrylate, polyether tetraacrylate, or combinations thereof.

26. The energy storage module of claim 19, wherein the binder is from about 5 to 10 wt % of total weight of the absorbent additive and the binder.

27. The energy storage module of claim 19, wherein the acidic material comprises an organic acid, an organic acid anhydride, or combinations thereof.

28. The energy storage module of claim 27, wherein the acidic material comprises citric acid, tartaric acid, stearic acid, salicylic acid, succinic acid, maleic acid, maleic anhydride, phthalic acid, phthalic anhydride, naphthalic acid, naphthalic anhydride, derivatives thereof, or combinations thereof.

29. The energy storage module of claim 27, wherein the acidic material comprises poly(styrene-co-maleic anhydride), poly(maleic anhydride-alt-1-octadecene), poly(propylene-graft-maleic anhydride), poly(styrene-co maleic anhydride), polystyrene-alt-maleic anhydride), poly(ethylene-co-ethyl acrylate-co-maleic anhydride), polyethylene-graft-maleic anhydride, polypropylene-graft-maleic anhydride, polyisoprene-graft-maleic anhydride, poly(ethylene-alt-maleic anhydride), poly(isobutylene-alt maleic anhydride), poly(methyl vinyl ether-alt-maleic anhydride), poly(maleic anhydride-alt-1-octadecene) or combinations thereof.

30. The energy storage module of claim 19, wherein the acidic material is about 15 to 25 wt % of total weight of the absorbent additive and the binder.

31. The energy storage module of claim 19, wherein the absorbent additive comprises cotton, starch, cellulose, polysaccharide, polyacrylate, poly(diacetone-acrylamide), polyvinylalcohol, poly(ethylene glycol)diacrylate, silica, poly-2-hydroxyethyl methacrylate, agarose, 2-hydroxyethyl methacrylate (HEMA), trimethylpropane ethoxylate triacrylate or combinations thereof.

32. The energy storage module of claim 19, wherein the absorbent additive is from about 90 to 95 wt % of total weight of the absorbent additive and the binder.

33. The energy storage module of claim 19, wherein the at least one energy storage device comprises an alkaline battery, an alkaline capacitor or combinations thereof.
